(19) United States
(12) Patent Application Publication
(10) Pub. No.: US 2024/0328756 A1
(43) Pub. Date: Oct. 3, 2024

(54) Textile Fabrics and Methods of Manufacture

(71) Applicant: Christopher Gabriel Williams, Milford, CT (US)

(72) Inventor: Christopher Gabriel Williams, Milford, CT (US)

(21) Appl. No.: 18/599,680

(22) Filed: Mar. 8, 2024

Related U.S. Application Data
(60) Provisional application No. 63/493,471, filed on Mar. 31, 2023.

(51) Int. Cl. F41H 1/02; B32B 5/02; B32B 5/26; D04H 1/593; D04H 1/655

(52) U.S. Cl. CPC F41H 1/02; B32B 5/024; B32B 5/263; D04H 1/593; D04H 1/655; B32B 2250/04; B32B 2250/05; B32B 2250/20; B32B 2437/00; B32B 2571/02; D10B 2501/04

(57) ABSTRACT

Tows of fiber are mingled with resin, wrapped in layers on a mandrel, and the layers are adhered to each other and cured on the mandrel. After all layers have been wrapped and adhered to each other and cured, thereby forming a fabric panel, the fabric panel is cut along the length of the mandrel and peeled from the mandrel. The length of the fabric panel then is wrapped around a roll. In other words, the roll is shorter than the mandrel and, with respect to the fabric panel, the roll is oriented perpendicular to the mandrel. Fibers in different layers of the fabric panel may be disposed at different angles with respect to the length of the fabric panel. Two, three, four, five, or more layers may be provided on the fabric panel.

### CROSS-REFERENCE TO RELATED APPLICATIONS

This application is a non-provisional application that claims the benefit of U.S. Provisional Application 63/493,471, which was filed Mar. 31, 2023.

### TECHNICAL FIELD

This application relates to textile fabrics and the manufacture thereof, and, more particularly, to textile fabrics that incorporate fibers in a resin matrix.

### BACKGROUND

Fabrics made of composite laminated materials or woven materials are used in many commercial products. The cost to manufacture these fabrics can be an expensive endeavor that can impact the manufacturers bottom line. Furthermore, the fabrics are manufactured to fit general specifications or have general specifications that can be used to design a product according to its intended application. Performance, quality, and cost are specification variables designers take into consideration when designing and developing a product for an intended use.

Standard processes for manufacturing fabrics using composite laminated materials and woven materials can involve the use of simple machinery or highly sophisticated machinery, depending on the intended application of the fabric. In the former case, the processes lack a measure of refinement or otherwise impose limitations that introduce cost and compromise quality, such as durability and reliability. In the latter case, substantial capital is required to implement and execute the processes; the fabrics manufactured are very expensive; the processes are very time consuming, which further adds to the cost; and the processes produce waste in the form of byproducts that must be managed, which further adds to the costs.

Traditional woven plys are limited in yarn type and yarn angles. Weight and thickness can be adjusted adequately.

Similarly, laminated materials are limited in thickness as common practice is to ensure that there is film to film or taffeta to taffeta lamination between the outer skins to ensure high bond strength. Laminators traditionally only allow for up to four yarn angles, warp, fill and a +/−bias angle. That is, laminators generally are not capable of inserting yarns in more than four axes.

Additionally, composite laminated materials and woven materials are made with component parts that have performance characteristics that make the materials not suitable for certain product applications or result in products designed with less-than-optimal performance characteristics.

As previously stated, existing processes used in the manufacture of fabrics using composite laminated materials and woven materials are performed using simple machinery or high-end machinery. The machinery driven processes have their own advantages as well as disadvantages that will be discussed in more detail below.

In this specification, the term warp can refer to a length along the length of material and in the proposed production method along the length of a mandrel. The term fill can refer to the direction across the width of cloth and in the proposed production method around a mandrel. The term bias can refer to a bias seam, stitch, tape, fiber, yarn, or tow across the cloth diagonally. The term weft can refer to a curve in a woven material.

Additionally, crimp is a bending of yarns as they are woven over and under adjacent yarns. Filament is an individual fiber. Fiber is a type or class of materials. Yarn is a group or bundle of filaments, typically thousands of individual filaments. Unidirectional refers to a set of fibers being parallel to one another. Tow refers to yarn that has been flattened.

Pre-preg refers to a tow of filaments which have been flattened and pre-impregnated with resin. Wet-preg refers to a tow of filaments which have been flattened and impregnated with resin during the manufacturing process. Composite refers to multiple materials mixed together to form a material that is stronger or has specific properties which are greater than the individual components.

Furthermore, in this specification, cloth and fabric are used interchangeably. Tape is used interchangeably with a tow of fibers or a ribbon of unidirectional fibers. Tow-Preg can be interchanged with wet-Preg.

Normal woven Dacron cannot mix multiple fiber types. For example, using polyester for durability and Dyneema for strength or Dyneema for strength and carbon for additional modulus. This is because when you heat shrink a Dacron cloth the polyester shrinks more than any other fibers would. This induces crimp on the secondary yarn types which renders those yarns ineffective.

Similarly, Aramid, carbon and Dyneema fibers cannot be heat shrunk which means that weaving these fiber types isn't practical because the weave is too loose. The only way to stabilize a woven high modulus cloth to date has been to laminate it with a film or taffeta to keep the weave from hefting.

### Lower Cost Manufacturing Processes

Equipment used in a first manufacturing process to manufacture cloth made of laminated yarns and films include hundreds of spindles of yarns, a basin filled with liquified resin, a heated set of nip rollers & film take-up and let-off winders. This manufacturing process includes pulling yarns from the spindled mandrel and bathing the yarns in the resin basin. The bathed fibers are Inserted between two mandrels of mylar or PET films in various yarn directions which are computer controlled depending on the intended application. Different weight yarns or yarn types are used as well as different film weights or types (clear, opaque, woven backed, taffeta, etc.) depending on the application.

The fabrics manufactured from this first process are less durable and reliable because the bonds in the laminate age prematurely and, therefore, breakdown over time. This breakdown process is accelerated with use. Additionally, laminates with films tend to shrink with use as wrinkles are introduced to the films. This adds crimp to the fibers which alters the materials properties negatively. The fabrics also lack optimal performance characteristics due to the types of resins used in the bathing process. Additionally, laminated cloths are more expensive and require much more complicated production processes than that of other non-laminated materials and, therefore, can add costs in the production of these types of fabrics and products made of such fabrics.

Equipment used in a second manufacture process of a fabric made of woven materials includes hundreds of spindled yarn rolls and a loom for weaving the fabric. This manufacturing process includes pulling warp (along the length of a loom) yarns from hundreds of spindled mandrels and weaving fill (across the loom) yarns over and under each individual warp yarn. Limiting product designs to axes orientations of 0-degrees and 90-degrees precludes this material from being used in high performance applications and reduces durability. In addition, fibers must be woven over and under one another and this crimps the fibers. Although crimped fiber may be a good feature for product designs that benefit from a bulky and flexible fabric, product designs that require a high degree of durability and performance do not.

Further, the manufacturing process is very slow and energy inefficient and, therefore, adds cost due to production time. Furthermore, products designed using woven materials are made from polyester yarns. Polyester yarn is a low performance yarn. To further strengthen the yarns for use in certain applications, the yarns are heat and resin set to further tighten the weave and stabilize the bias direction with tighter fabric weave. Lastly, weft is common in woven materials depending on the finishing quality, which also reduces performance. As such, fabric made from woven polyester is a heavy, stretchy material and not suitable for performance applications.

In summary, the first manufacturing process uses laminated cloth of yarns and film and can produce high-quality and high-performance fabrics, but the laminates are less durable and reliable because of bond degradation. The second manufacturing process uses woven material and can produce durable and tough fabrics but at a high weight and low performance. In addition, this manufacturing process is slow and energy inefficient, which also adds to the cost.

### Higher Cost Manufacturing Processes

Equipment used in a particular manufacturing process for manufacturing fabrics created from fiber composite tapes for use as ship sails, boat sails, or sails for sailboards includes robotic machinery, pre-preg tape segments, and mold to form the sails on. The pre-preg tape segments comprise tows of fibers and a back plane, e.g., paper, coated with a wax. The manufacturing process includes using the robotic machinery to lay the tape segments onto the table in very intricate patterns.

The intricate patterns can consist of 1,000-100,000 individually laid tape segments which are stacked into between 4-100 layers thick. By layering the tapes and eliminating the film the manufactured fabric can be used to make high performance sails that are very durable and reliable. The structure of tape segments is then laid over a 3D mold that is molded into the shape of a particular sail design. This laid structure is then vacuum bagged to the mold surface and heated to cure the pre-preg resin in a single piece composite laminate sail.

In a final manufacturing process, yarn strings can be used instead of tapes to manufacture fabrics created from laminated films and yarns. In this process, the tape segments are replaced with film. String laminates are a type of sail made of laminated films with strings of yarn imposed thereon. The strings of yarn are imposed on the laminated surface using robotics and are positioned on the film to align with anticipated loads to be expected on a product, such as a sail. After all the strings or tows of yarn have been laid, another layer of film is laid to encapsulate the yarn between two outer layers of film. Generally, the films are vacuum bagged together and laminated with IR heat or nipped under large, heated metal or rubber rollers. These materials are used to create the fabric that is then used to create the sail at the same time. However, this method is expensive and the fabric prematurely ages in the same manner described above typically by delamination of the film layers, which are essentially separated by the tows of yarn between them. Additionally, large plotters are needed to robotically lay out the fibers and then vacuum bag and heat the laminate up at the same time.

In summary, each of the manufacturing techniques discussed above for making sails are time-consuming processes, expensive, and yield lots of waste. In the case of the tape structure, the coated back release paper is very expensive and discarded after the tapes are laid into position. Sails built using these techniques can cost, on average, approximately $20,000 each and, in extreme cases, can cost as much as $750,000 each.

### SUMMARY

This application teaches technology for making a fiber-resin textile fabric by wrapping tows of fiber in spiral fashion around a mandrel in multiple layers that are adhered to the mandrel and to each other and are not interwoven. Such a filament winding process not only allows for any number of different fiber angles, but also a much higher number of layers and thickness. This can be useful in setting up prepreg composites that would require far fewer debulking processes during the laminate layup vs the typical practice of only adding single unidirectional and/or biaxial prepreg sheets at a time between debulking. Thicker plys formed with a filament winding process may also be a more cost-effective way of producing ballistic armor rather than cutting out and stacking many layers of individually cut and placed sheets of fabric. Additionally, filament wound fabric does not require heat setting and therefore multiple fiber types can be used creating a composite cloth.

In some embodiments, the tows of fiber are formed in pre-preg tapes. In other embodiments, the tows of fiber are wet-preg as discussed above.

The tows are wrapped in at least two layers. Additional layers may be provided, i.e., three, four, five, or more layers of tows, with each layer adhered to the preceding layer. The first layer of tows may be wrapped at a first non-zero angle with respect to the length of the mandrel. The second layer of tows may be wrapped at a second non-zero angle with respect to the length of the mandrel. Each layer of tows may be wrapped at a different non-zero angle with respect to the length of the mandrel. On the other hand, two or more layers of tows may be wrapped at the same non-zero angle with respect to the length of the mandrel.

After all layers have been wrapped and adhered to each other, thereby forming a fabric panel, the fabric panel is cut along the length of the mandrel and peeled from the mandrel. The length of the fabric panel then is wrapped around a roll. In other words, the roll is shorter than the mandrel and, with respect to the fabric panel, the roll is oriented perpendicular to the mandrel.

In some embodiments, at least one layer of the fabric panel has fibers that are oriented parallel to the axis of the roll and at least one layer of the fabric panel has fibers that are oriented at a non-zero angle with respect to the axis of the roll. However, in some embodiments, all the layers of the fabric panel have fibers that are oriented at a non-zero angle with respect to the axis of the roll.

One application of the present teachings is for forming sails to be used on watercraft. Such a sail may have multiple fabric panels, which are attached to each other by seams or joiners. Load directions in a sail underway are multi-directional and, as such, the fabric panels may be arranged such that their fibers are oriented along the directions of the various loads on each panel. Because the technology of this application provides for fabric panels with almost any number of layers of fibers oriented in almost any direction, sails that embody this technology may be able to handle more directions of loading compared to conventional sails.

Another application of the present teachings is for making ballistic clothing, e.g., ballistic impact vests. Such clothing may have multiple fabric panels that are layered atop each other. Because the technology of this application provides for fabric panels with more layers than can be achieved by conventional modes of making fiber-resin fabric, ballistic clothing that embodies this technology may be made with fewer panels of fabric, thus, less labor compared to conventional ballistic clothing. Additionally, energy absorbing resins can be introduced to further enhance the materials impact resistance.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 depicts an example of a machine for making fabric panels according to an aspect of the present teachings.

FIG. 2 depicts the mandrel of the machine shown in FIG. 1, with a cut panel of fabric being peeled from the mandrel.

FIG. 3 depicts the fabric panel that is shown in FIG. 2, being wrapped around a roll.

FIG. 4 depicts an “exploded” view of a multi-layer fabric panel with fibers oriented at different angles with respect to the length of the panel.

FIG. 5 depicts a sail that is composed of multiple fabric panels with arrows depicting the directions of principal loads in the sail according to an aspect of the present teachings.

FIG. 6 depicts a ballistic clothing product that is composed of at least one fabric panel, which comprises multiple layers of fiber and resin.

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

The present teachings have been described in language more or less specific as to structural, mechanical, and functional features. It is to be understood, however, that the present teachings are not limited to the specific features shown and described, since the apparatus, system, and/or method herein disclosed comprises preferred forms of putting the present teachings into effect.

For purposes of explanation and not limitation, specific details are set forth such as particular structures, architectures, interfaces, techniques, etc., in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to “a/an/the element, apparatus, component, means, step, etc.,” are to be interpreted openly as referring to at least one instance of the element, apparatus, component, means, step, etc., unless explicitly stated otherwise. The use of “first”, “second,” etc., for different features/components of the present disclosure are only intended to distinguish the features/components from other similar features/components and not to impart any order or hierarchy to the features/components, unless explicitly stated otherwise. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C.

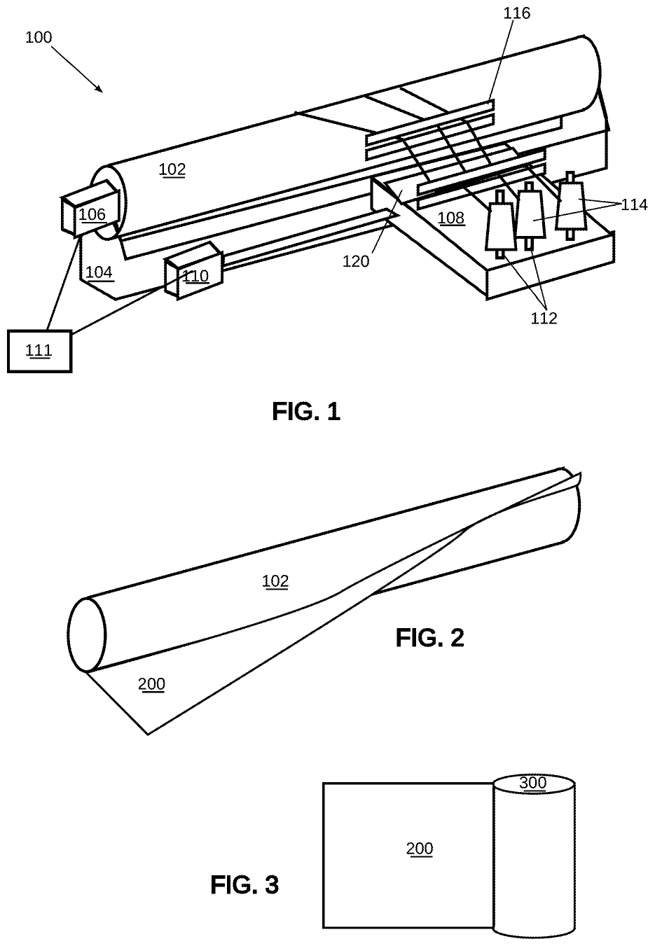

FIG. 1 depicts an example of a machine 100 for making fabric panels according to an aspect of the present teachings. The machine 100 comprises a mandrel 102, which is mounted on a chassis 104, and a mandrel motor 106 that is connected between the mandrel and the chassis for rotating the mandrel around its length. In some embodiments, the mandrel may rotate at up to 2 m/s surface speed. The mandrel may be as long as 10 m with a circumference up to 1.5 m.

The machine 100 also comprises a carriage 108 and a carriage motor 110 that is connected between the carriage and the chassis for moving the carriage along the mandrel. In some embodiments, the carriage motor 110 also may be connected to move the carriage around the mandrel and/or perpendicular to the length of the mandrel. A controller 111 coordinates operation of the motors 106, 110 for moving the mandrel and the carriage. The carriage may move at up to 5 m/s. Spindles 112 are mounted on the carriage 108. One or more reels 114 of yarn or pre-preg tape are held on the spindles.

If yarn is used, then pinch rollers 116, which are operated by a motor (not shown), may feed one or more tows of the yarn from the reels to the rotating mandrel. The pinch rollers may be arranged to briefly submerge the yarn in a resin bath 120 so as to wet-preg the tow of yarn, thereby mingling a resin with fibers of the yarn. The resulting material comprises one or more ribbons of continuous wet-preg composite with a particularly high filament count. Wet-preg is a term used in association with a reinforcing fabric that has been impregnated with a system of resins. Wet-preg composite tows typically have a high tensile strength that is well suited for use as a laminated composite in the manufacture of fabric requiring high levels of strength and stiffness (resistance to stretch).

The wet-preg ribbons may consist of a combination of one or more of carbon, Aramid, Dyneema, UPE, and/or polyester fibers with a thermoplastic or thermoset resin as binder material. The resin system, e.g., typically a rubberized epoxy or flexible polyester or urethane resin, often includes a curing agent for thermal, infrared, visible light, or UV light curing. Suitable curable resins, and methods for curing them, are well-known in the art.

If pre-preg tape is used, then the pinch rollers and resin bath may be omitted. Tape may be fed from reels directly to the mandrel. In some embodiments, the spindles and reels may be differently oriented than is shown in FIG. 1 and may be adjustable in their orientation with respect to the carriage and/or the mandrel, so as to optimize the angle at which the tape contacts the mandrel.

By changing the speed that the mandrel rotates, the speed that the moveable carriage moves back and forth, or both, the angle of the yarn/ribbons/tows with respect to the length of the mandrel can be varied (e.g., almost 0 degrees to 90 degrees), and multiple layers can be added to offer multidimensional orientations of strength to the fabric. In an alternative embodiment, the mandrel can be rotated from 0 degrees (parallel with respect to its vertical axis) to 90 degrees (parallel with respect to its horizontal axis). In another embodiment, the positions and movements of the mandrel and the carriage can be manipulated in combination to create a fabric with a greater textile strength.

After the yarn or tape has been adhered to the mandrel, however many layers are desirable, the layers may be cured on the mandrel by application of heat and/or light to the mandrel. Heat may be applied from the inside of the mandrel. Heat and/or light may be applied by illuminating the outer surface of the mandrel. Suitable heating coils or lamps, which may be movable along the mandrel, are well-known and are omitted from the drawing figures so as not to distract from illustration of other components.

After the layers have been cured, they can be cut and unwrapped or peeled from the mandrel to form a fabric panel.

FIG. 2 depicts the mandrel 102 of the machine shown in FIG. 1, with a cut panel of fabric 200 being peeled from the mandrel.

FIG. 3 depicts the fabric panel 200 that is shown in FIG. 2, being wrapped around a roll 300.

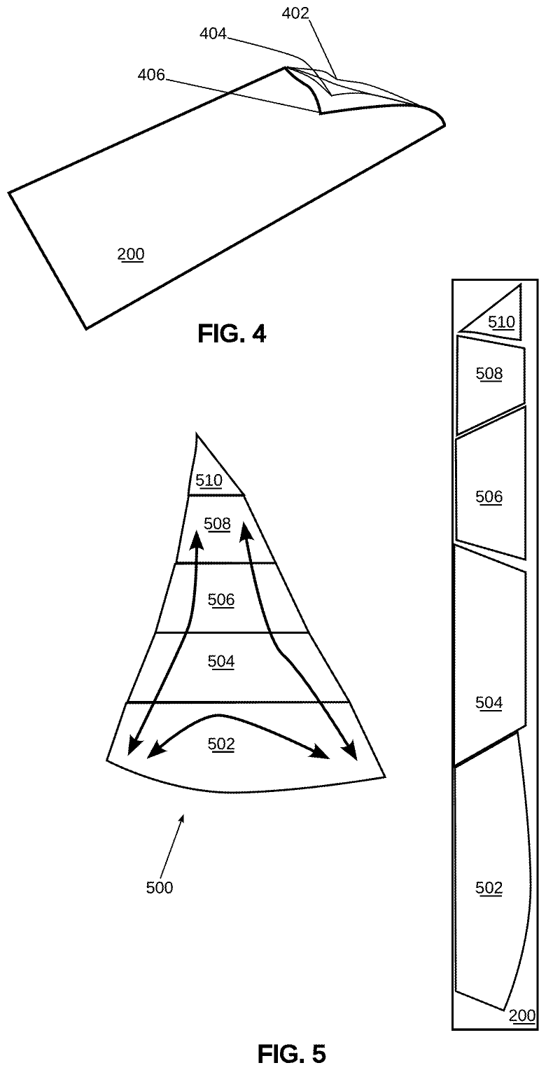

FIG. 4 depicts an “exploded” or “frayed” view of the multi-layer fabric panel 200 showing layers 402, 404, 406 with fibers oriented at different angles with respect to the length of the panel. For example, the layer 402 may have fibers oriented almost parallel with respect to the length of the panel, the layer 404 may have fibers oriented at an acute non-zero angle with respect to the length of the panel and the layer 406 may have fibers oriented perpendicular with respect to the length of the panel.

In practice, the adhesion of the multiple resin layers to each other may enable the panel to withstand fraying under use. Additionally, the adhesion of the multiple resin layers to each other may mitigate the problem of delamination that can occur when multiple layers of fibers are sandwiched between outer film layers.

FIG. 5 depicts a sail 500 that is composed of multiple sections 502, 504, 506, 508, 510 that were cut from a fabric panel such as the fabric panel 200, with arrows depicting the directions of principal loads in the sail according to an aspect of the present teachings.

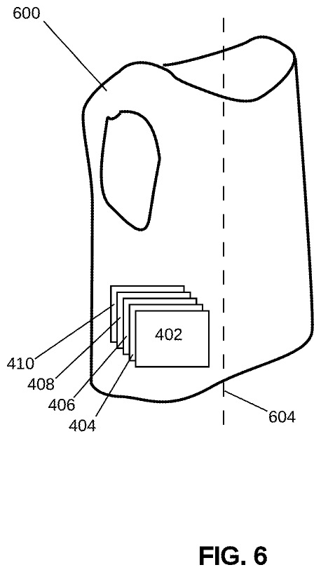

FIG. 6 depicts a ballistic clothing product 600 that is composed of at least one fabric panel 200, which comprises multiple layers of fiber and resin, e.g., first, second, third, fourth, and fifth layers 402, 404, 406, 408, 410. The product 600 has a major axis 604, and the fibers in each of the layers of the fabric panel are disposed at different angles from each other with respect to the major axis 604.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed is:

1. A method for making a fabric panel, the method comprising:
wrapping a first layer of fibers around a mandrel at a first angle to the axis of the roll;
wrapping a second layer of fibers around the mandrel at a second angle to the axis of the mandrel;
mingling resin with the layers of fibers;
forming the fabric panel by curing the resin on the mandrel;
unwrapping the fabric panel from the mandrel.

2. The method of claim 1, wherein mingling the resin with the layers of fiber comprises supplying the fibers to the mandrel in tapes that comprise the fibers in a resin matrix.

3. The method of claim 1, wherein mingling the resin with the layers of fibers comprises supplying the resin to the mandrel.

4. The method of claim 3, wherein supplying the resin to the mandrel comprises passing each fiber through a resin bath before wrapping the fiber on the mandrel.

5. The method of claim 1, wherein curing the resin on the mandrel comprises heating the mandrel.

6. The method of claim 5, wherein heating the mandrel comprises supplying electrical current to resistors inside the mandrel.

7. The method of claim 1, wherein curing the resin on the mandrel comprises supplying light to the outside of the mandrel.

8. The method of claim 1, wherein the second angle is within 45 degrees from the first angle.

9. An apparatus for making a fabric panel, the apparatus comprising:
a chassis;
a mandrel that is rotatably mounted on the chassis;
a mandrel motor that is connected between the chassis and the mandrel to drive rotation of the mandrel on the chassis;
a carriage that is movably mounted on the chassis;
one or more fiber dispensers that are rotatably mounted on the carriage;
a carriage motor that is connected between the carriage and the chassis to drive motion of the carriage; and
a controller that is connected with the mandrel motor and the carriage motor to coordinate rotation of the mandrel with motion of the carriage.

10. The apparatus of claim 9, wherein the one or more fiber dispensers comprise one or more spindles with reels of yarn on the spindles, further comprising a resin bath that is mounted on the carriage between the spindles and the mandrel.

11. The apparatus of claim 10, further comprising pinch rollers that are mounted to guide the yarn from the reels, through the resin bath, to the mandrel.

12. The apparatus of claim 11, wherein the pinch rollers are mounted to the carriage.

13. The apparatus of claim 9, wherein the one or more fiber dispensers comprise one or more spindles with reels of tape on the spindles.

14. A product comprising:
a roll;
a first layer of resin and fibers in which the fibers are wrapped around the roll at a first non-zero angle to the axis of the roll;
a second layer of resin and fibers in which the fibers are wrapped around the roll at a second non-zero angle to the axis of the roll;
wherein the first layer and the second layer are adhered to each other.

15. The product of claim 14, wherein the first layer and the second layer are wrapped multiple times around the roll.

16. The product of claim 14, further comprising a third layer of resin and fibers in which the fibers are wrapped around the roll at a third non-zero angle to the axis of the roll, wherein the third layer is adhered to the second layer.

17. The product of claim 16, wherein the third layer is coextensive with the second layer.

18. The product of claim 16, further comprising a fourth layer of resin and fibers in which the fibers are wrapped around the roll at a fourth non-zero angle to the axis of the roll, wherein the fourth layer is adhered to the third layer.

19. The product of claim 18, wherein the fourth layer is coextensive with the third layer.

20. The product of claim 19, wherein the first, second, third, and fourth angles are different from each other.

21. A ballistic clothing product comprising:
a first layer of resin and fibers in which the fibers extend at a first angle to a major axis of the product;
a second layer of resin and fibers in which the fibers extend at a second non-zero angle to a major axis of the product;
a third layer of resin and fibers in which the fibers extend at a third non-zero angle to a major axis of the product;
a fourth layer of resin and fibers in which the fibers extend at a fourth non-zero angle to a major axis of the product; and
a fifth layer of resin and fibers in which the fibers extend at a fifth non-zero angle to a major axis of the product;
wherein the first and second layers are adhered to each other, the third layer is adhered to the second layer, the fourth layer is adhered to the third layer, and the fifth layer is adhered to the fourth layer.

22. The product of claim 21, wherein two or more of the first, second, third, fourth, and fifth angles are different from each other.

23. The product of claim 21, wherein all of the first, second, third, fourth, and fifth angles are different from each other.
